(19) United States
(12) Patent Application Publication
(10) Pub. No.: US 2026/0219654 A1
(43) Pub. Date: Jul. 30, 2026

(54) INFORMATION PROCESSING APPARATUS AND PROGRAM

(71) Applicant: FANUC CORPORATION, Yamanashi (JP)

(72) Inventor: Shinji KURIHARA, Yamanashi (JP)

(21) Appl. No.: 19/145,942

(22) PCT Filed: Jan. 20, 2023
(86) PCT No.: PCT/JP2023/001750

§ 371 Date: Jul. 6, 2025

(51) Int. Cl. G05B 19/418

(52) U.S. Cl. CPC G05B 19/41865; G05B 2219/32021

(57) ABSTRACT

An information processing apparatus according to the present disclosure includes a storage unit to store a plurality of operation programs for individually controlling a plurality of robot devices that execute a task in cooperation with each other, an operation program candidate creation unit configured to create a plurality of operation program candidates with different individual power consumptions for each of the plurality of robot devices based on the operation program of the robot device, and a combination creation unit configured to create a combination of operation program candidates for the plurality of robot devices so that a total value of individual power consumptions for the plurality of robot devices is less than a total power consumption of the plurality of robot devices when the robot devices are operated in accordance with the operation programs.

### RELATED APPLICATIONS

The present application is a National Phase of International Application No. PCT/JP2023/001750 filed Jan. 20, 2023.

### TECHNICAL FIELD

The present disclosure relates to an information processing apparatus and a program having a function of assisting a user in modifying an operation program.

### Background Art

In recent years, efforts to address the Sustainable Development Goals (SDGs) and Corporate Social Responsibility (CSR) have become indispensable from the perspective of corporate management. On the other hand, industrial machines such as robot devices that use a lot of electric power have been deployed in factories and the like to improve the working environment and to supplement the working population. Companies that use a lot of industrial machines such as robot devices are making efforts to address the SDGs by maintaining and inspecting industrial machines at optimal times to eliminate unnecessary parts replacement and reduce the power consumption of the robot devices. As a technique for supporting such efforts, a technique of suppressing the peak voltage by offsetting the start timings of a plurality of robot devices is known (for example, Patent Literature 1). In addition, efforts have been made to reduce the power consumption of a robot device by modifying the operation program of the robot device to reduce the operation speed of the robot device, for example.

### CITATION LIST

### Patent Literature

Patent Literature 1: Japanese Unexamined Patent Application Publication No. 2017-162300

### SUMMARY

### Problem to be Solved

However, it is not easy for a user who is unfamiliar with the operation and setting of the robot device to modify the operation program so as to reduce the power consumption. Therefore, from the viewpoint of reducing the power consumption, it is desired to propose a technique for assisting the user in modifying the operation program.

### Solution to Problem

An information processing apparatus according to the present disclosure includes a storage unit to store a plurality of operation programs for individually controlling a plurality of robot devices that execute a task in cooperation with each other, an operation program candidate creation unit configured to create a plurality of operation program candidates with different individual power consumptions for each of the plurality of robot devices based on the operation program of the robot device, and a combination creation unit configured to create a combination of operation program candidates for the plurality of robot devices so that a total value of individual power consumptions for the plurality of robot devices is less than a total power consumption of the plurality of robot devices when the robot devices are operated in accordance with the operation programs.

### BRIEF DESCRIPTION OF THE DRAWINGS

FIG. 1 shows a robot system including an information processing apparatus according to the present embodiment.

FIG. 2 is a hardware configuration diagram of the information processing apparatus according to the present embodiment.

FIG. 3 is a functional block diagram of the information processing apparatus according to the present embodiment.

FIG. 4 shows an example of a robot information management table stored in a storage unit shown in FIG. 3.

FIG. 5 shows an example of a power consumption history database for each robot device, which is stored in the storage unit shown in FIG. 3.

FIG. 6 shows an example of a first reception screen displayed on a display unit shown in FIG. 3.

FIG. 7 shows another example 1 of the first reception screen displayed on the display unit shown in FIG. 3.

FIG. 8 shows another example 2 of the first reception screen displayed on the display unit shown in FIG. 3.

FIG. 9 shows another example 3 of the first reception screen displayed on the display unit shown in FIG. 3.

FIG. 10 shows an example of a second reception screen displayed on the display unit shown in FIG. 3.

FIG. 11 shows an example of a third reception screen displayed on the display unit shown in FIG. 3.

FIG. 12 shows another example 1 of the third reception screen displayed on the display unit shown in FIG. 3.

FIG. 13 shows another example 2 of the third reception screen displayed on the display unit shown in FIG. 3.

FIG. 14 is a first supplementary diagram for explaining processing for creating operation program candidates by a operation program candidate creation unit shown in FIG. 3.

FIG. 15 is a second supplementary diagram for explaining the processing for creating operation program candidates by the operation program candidate creation unit shown in FIG. 3.

FIG. 16 is a supplementary diagram for explaining processing for creating combinations of operation program candidates by a combination creation unit shown in FIG. 3.

### DETAILED DESCRIPTION

Hereinafter, an information processing apparatus according to an embodiment of the present invention will be described with reference to the drawings. In the following description, constituent elements having substantially the same function and configuration are denoted by the same reference numeral, and repetitive descriptions will be given only where necessary.

The information processing apparatus according to the present embodiment includes a function of assisting a user in selecting a robot device whose operation program is to be modified, and a function of assisting a user in modifying the operation program.

The modification of the operation program is performed so that the total power consumption of a plurality of robot devices that perform one task in cooperation can be reduced. Therefore, among the plurality of robot devices that perform one task in cooperation, there may be a robot device whose individual power consumption increases due to the modification of the operation program as compared with the power consumption before the modification of operation programs.

It is noted that the target whose operation program is to be modified is not limited to a robot device, but may be any industrial machine such as a machine tool. Of course, the plurality of industrial machines that perform one task in cooperation may be the same type of industrial machine or a plurality of types of industrial machines.

Typically, the information processing apparatus according to the present embodiment is configured as follows.

Note that, in the present embodiment, terms are defined as follows.

Robot Group: A plurality of robot devices that perform one task in cooperation. For example, the robot group includes a plurality of robot devices arranged on the same production line, a plurality of robot devices that operate in cooperation, and the like. In the present embodiment, the same line name is assigned to a plurality of robot devices arranged on the same production line. The same group name is assigned to a plurality of robot devices that operate in cooperation. A production line may include a plurality of groups.

Operation Program: A program being set in a robot device, which describes a procedure for causing the robot device to execute an individual work, a type of operation to be executed, an operation condition at the time of execution, and the like.

Operation Program Candidate: Similar to the operation program, the operation program candidate is a program describing a procedure for causing the robot device to execute an individual work, a type of operation to be executed, an operation condition at the time of execution, and the like, and is a candidate to replace the operation program set for a robot device.

Individual Cycle Time: The time required from the start to the end of an operation of one robot device according to an operation program or an operation program candidate.

Total Cycle Time: The sum of the individual cycle times of a plurality of robot devices. While one of the robot devices constituting a robot group is operating, another robot device may operate; therefore, the total cycle time may not be the sum of the individual cycle times of the plurality of robot devices. For example, in the case of a fully automated production line, the total cycle time corresponds to the cycle time assigned to the production line.

Individual Power Consumption: The amount of electric power consumed by one robotic device from the start to the end of the operation according to the operation program.

Total Power Consumption: The sum of the individual power consumptions of a plurality of robot devices.

Operation Time: The time during which the robotic device is actually moving during the individual cycle time.

Standby Time: The time during which the robotic device is not actually moving during the individual cycle time. For example, the standby time is also described in the operation program, and corresponds to a gap time from when the robot device ends one operation to when it starts another operation.

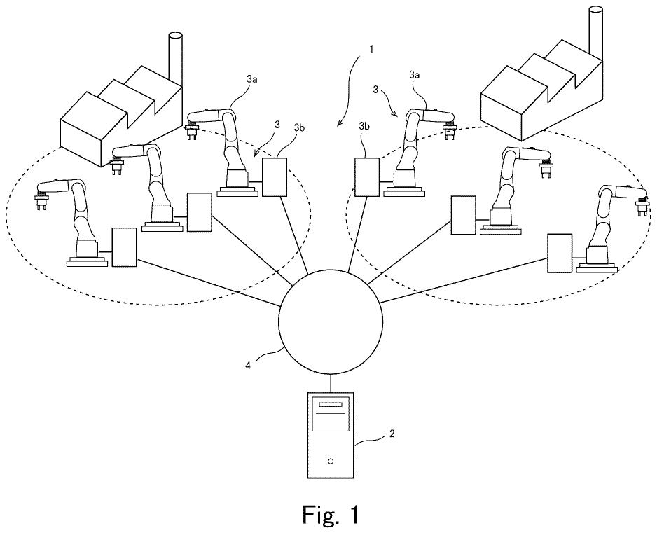

As shown in FIG. 1, an information processing apparatus 2 according to the present embodiment is connected to a plurality of robot devices 3 via a network 4 such as a LAN. The robot device 3 is composed of a robot body 3a realized by an articulated arm mechanism or the like, and a robot control device 3b that controls the robot body 3a. The robot device 3 has means, such as a power sensor, for measuring the power consumption of the robot device 3.

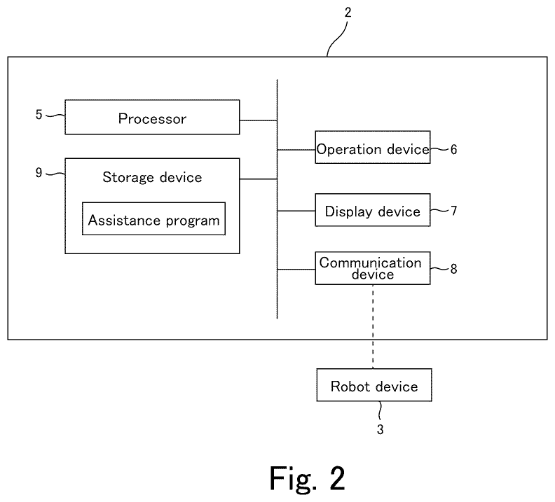

As shown in FIG. 2, the information processing apparatus 2 is configured by connecting hardware such as an operation device 6, a display device 7, a communication device 8, and a storage device 9 to a processor 5 such as a CPU.

The operation device 6 is implemented by a keyboard, a mouse, a jog, or the like. The operation device 6 may be implemented by a touch panel that also serves as the display device 7. The user can input various types of information to the information processing apparatus 2 through the operation device 6. The display device 7 is implemented by an LCD or the like. Various screens are displayed on the display device 7 under the control of the processor 5. The communication device 8 is implemented by a communication module conforming to any communication standard. The communication device 8 transmits and receives various types of data to and from an external device such as the robot device 3 under the control of the processor 5. The storage device 9 is implemented by an HDD, an SSD, or the like. The storage device 9 stores an assistance program and data necessary for executing the assistance program.

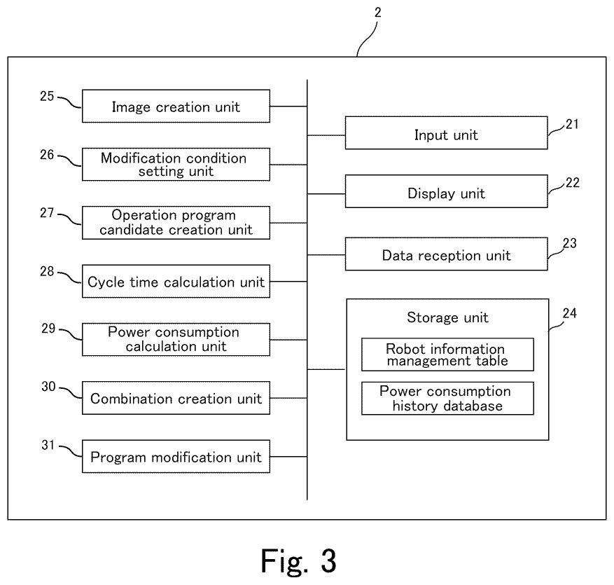

As shown in FIG. 3, when the assistance program stored in the storage device 9 is executed by the processor 5, the information processing apparatus 2 functions as an input unit 21, a display unit 22, a data reception unit (acquisition unit) 23, a storage unit 24, a screen creation unit 25, a modification condition setting unit 26, an operation program candidate creation unit 27, a cycle time calculation unit 28, a power consumption calculation unit 29, a combination creation unit 30, and a program modification unit 31.

The input unit 21 inputs input information from the user to the information processing apparatus 2. The input unit 21 is implemented by the function of the operation device 6 shown in FIG. 2. The information input to the information processing apparatus 2 through the input unit 21 includes selection information of a robot device 3 whose power consumption is to be displayed, input information of a robot device 3 whose operation program is to be modified, selection information of a modification condition of the operation program, selection information of one modification plan from a plurality of modification plans, and modification instruction information of the operation program.

The display unit 22 displays the various screens created by the screen creation unit 25. The display unit 22 is implemented by the function of the display device 7 shown in FIG. 2.

The data reception unit 23 receives various types of data from the robot device 3. The data reception unit 23 is implemented by the function of the communication device 8 shown in FIG. 2. Various types of data received from the robot device 3 include data related to the operation program and data related to the power consumption. Of course, as long as the information processing apparatus 2 can hold these types of data, the method of acquiring them is not limited to this.

The storage unit 24 stores various types of data necessary for processing related to the assistance function (assistance processing). The various types of data necessary for the assistance processing include a robot information management table, a power consumption history database, data necessary for screen creation by the screen creation unit 25, a calculation program used for calculation of an individual cycle time and a total cycle time by the cycle time calculation unit 28, a calculation program used for calculation of an individual power consumption and a total power consumption by the power consumption calculation unit 29, and the like. Details of the robot information management table and the power consumption history database will be described later.

The screen creation unit 25 creates a first reception screen for receiving a robot device 3 whose operation program is to be modified, a second reception screen for receiving a modification condition used for processing for modifying the operation program, and a third reception screen for receiving an instruction to modify the operation program. Details of the first reception screen, the second reception screen, and the third reception screen will be described later.

The modification condition setting unit 26 sets one modification condition selected from a plurality of modification conditions by a user operation on the second reception screen for combination creation processing by the combination creation unit 30 to be described later.

The operation program candidate creation unit 27 creates a plurality of operation program candidates based on the operation program of each of the robot devices 3. Details of the processing for creating operation program candidates will be described later.

The cycle time calculation unit 28 calculates an individual cycle time of the robot device 3 that operates in accordance with the operation program candidate created by the operation program candidate creation unit 27. The individual cycle time may be calculated using known techniques. For example, the individual cycle time can be calculated by adding the standby time to the operation time used to create the operation program candidate. In addition, the individual cycle time can be calculated by executing simulation of the operation of the robot device 3 based on the operation program candidate.

The power consumption calculation unit 29 executes simulation of the operation of the robot device 3 based on the operation program candidate created by the operation program candidate creation unit 27, thereby calculating the individual power consumption of the robot device 3 that operates in accordance with the operation program candidate. The individual power consumption can be calculated using known techniques.

For example, the power consumption calculation unit 29 estimates the power consumption of the robot device 3 based on the workload of the motor that drives each of the joints of the robot body 3a, the amount of heat generated by the motor, the amount of heat generated by the amplifier, and the amount of heat generated by the robot control device 3b.

The workload of the motor is calculated based on the current value of the current flowing through the motor and the speed of the motor. The amount of heat generated by the motor is calculated based on the current value and winding resistance of the motor. The amount of heat generated by the amplifier is calculated based on the current value of the motor. The amount of heat generated by the robot control device 3b is calculated based on the workload of each motor, the amount of power output by the robot control device 3b based on the amount of heat generated by each motor and the amount of heat generated by each amplifier, and the resistance of the robot control device 3b.

The speed of each motor is calculated by dividing the moving distance of the robot body 3a calculated by simulation based on the operation program of the robot body 3a by the unit time. The current value of each motor is calculated based on the torque applied to the shaft of the motor and the torque constant. The torque applied to the shaft of the motor is calculated by a known method using Newton's second law of motion, Euler's equation of motion, or the like.

The combination creation unit 30 creates combinations of operation program candidates for a plurality of robot devices 3 so as to satisfy a modification condition. Details of processing for creating combinations of operation program candidates will be described later.

The program modification unit 31 modifies the operation program of each of the plurality of robot devices 3. Specifically, the program modification unit 31 modifies the operation programs of the respective robot devices 3 by overwriting the operation programs set for the respective robot devices 3 with operation program candidates of the respective robot devices 3 created by the combination creation unit 30.

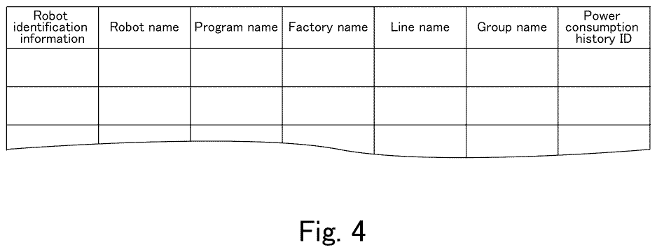

Hereinafter, the robot information management table will be described with reference to FIG. 4. FIG. 4 shows an example of the robot information management table. The robot information management table is a table that collectively show installation information of the robot devices 3 to be managed. For example, as shown in FIG. 4, in the robot information management table, robot identification information for identifying the robot device 3 is associated with a robot name, a program name, a factory name, a line name, a group name, and a power consumption history ID. The program name is an example of identification information for identifying an operation program set in the robot device 3. The factory name is an example of information for identifying a factory where the robot device 3 is installed. The line name is an example of information for identifying a line where the robot device 3 is arranged. The group name is an example of information for identifying a group to which the robot device 3 belongs. The power consumption history ID is an example of identification information for identifying a database (power consumption history database) relating to the history of the power consumption of the corresponding robot device 3.

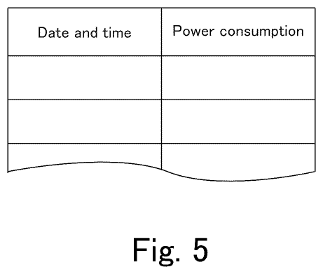

The power consumption history database will be described below with reference to FIG. 5. FIG. 5 shows an example of the power consumption history database. The power consumption history database is provided for each robot device 3. As shown in FIG. 5, in the power consumption history database, the power consumption is associated with date and time information. The power consumption of the robot device 3 over a predetermined period such as every cycle or every day can be calculated by referring to the power consumption history database and integrating the power consumptions. In addition, it is possible to identify the maximum value, the minimum value, the average value, and the like of the power consumption per cycle of the robot device 3 in a target period such as every day, every week, or every month.

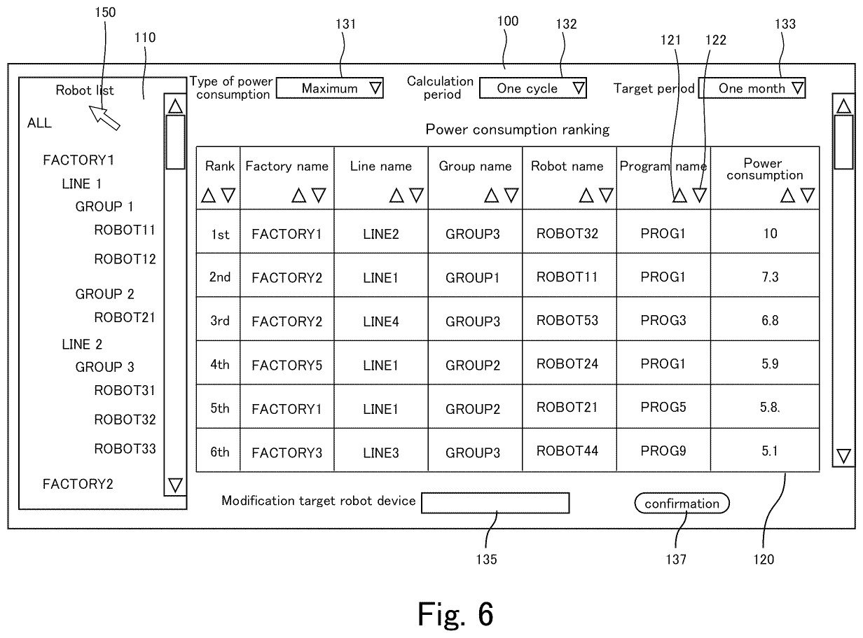

Hereinafter, the first reception screen will be described with reference to FIG. 6 to FIG. 9. FIG. 6 to FIG. 9 each show an example of the first reception screen created by the screen creation unit 25. The first reception screen has a function of receiving, from the user, the robot device 3 whose operation program is to be modified. In order to assist the user in selecting the modification target, a plurality of power consumptions corresponding to the plurality of robot devices 3 are displayed on the first reception screen. Typically, the plurality of power consumptions are listed in an arrangement according to the amount of power consumption. Preferably, the power consumption is displayed together with ranking information according to the power consumption, information for identifying a factory where the robot device 3 is installed, information for identifying a line where the robot device 3 is arranged, information for identifying a group to which the robot device 3 belongs, and information for identifying an operation program set in the robot device 3.

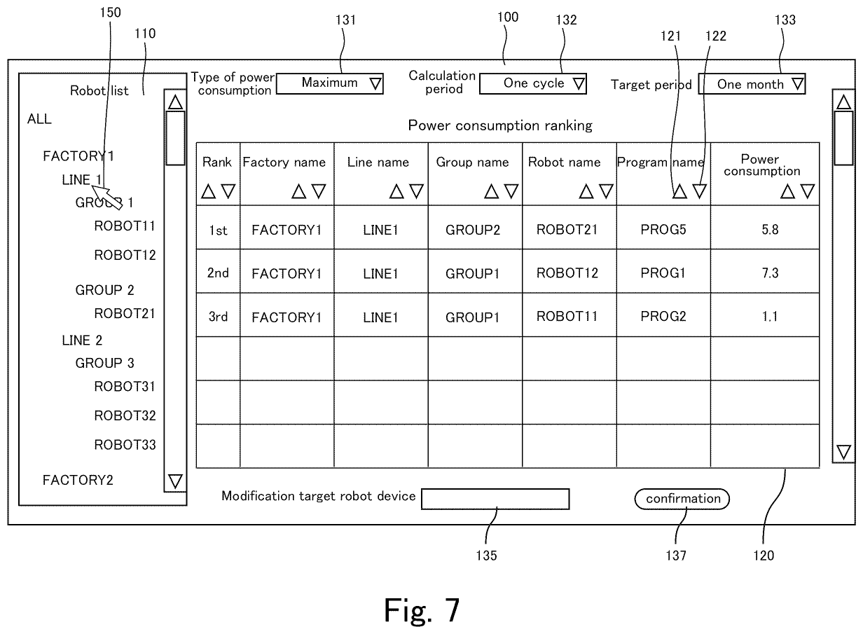

Specifically, as shown in FIG. 6, the first reception screen 100 displays a navigation tree 110 in which the robot devices 3 to be managed are shown in a tree form in accordance with the installation information. By a user operation on the navigation tree 110, it is possible to set a robot device 3 or a robot group whose power consumption is to be displayed. For example, the user can set a plurality of robot devices 3 (ROBOT11, ROBOT12) belonging to the robot group “GROUP1” as power consumption display targets by placing the cursor 150 on “GROUP1” and clicking it (see FIG. 7).

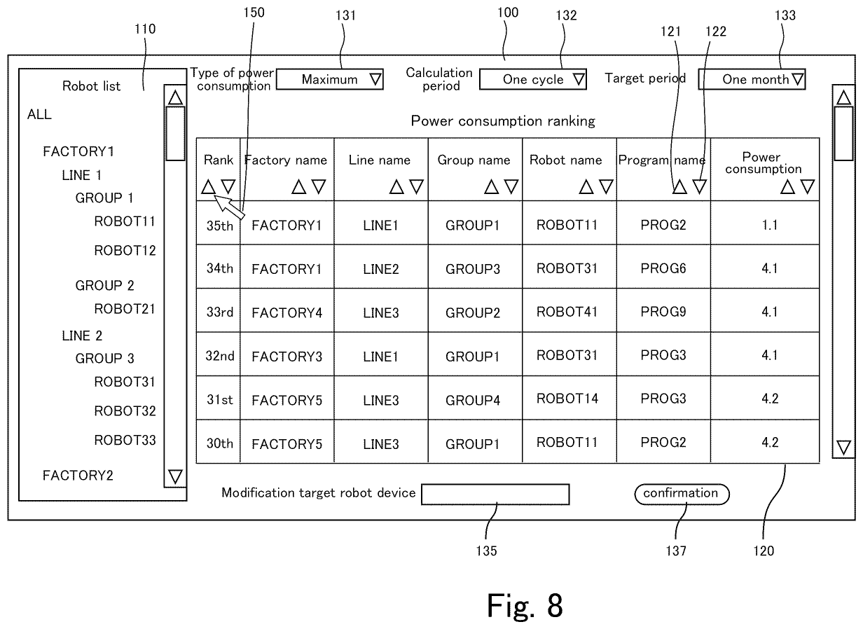

The power consumptions of the robot devices 3 selected by the user are displayed in a table form on the first reception screen 100. The table 120 includes a plurality of items such as ranking, factory name, line name, group name, robot name, program name, and power consumption. The ranking indicates the ranking of highest power consumption among the multiple power consumptions displayed in the table 120. For example, the rank “1 st” indicates that the power consumption is the highest among the plurality of power consumptions displayed in the table 120. An ascending button 121 and a descending button 122 are provided for each of the plurality of items. By operating the ascending button 121 or the descending button 122, the power consumptions can be rearranged in ascending or descending order (see FIG. 8). Further, the plurality of power consumptions can be rearranged and displayed by for each factory, line, group, or program (see FIG. 7).

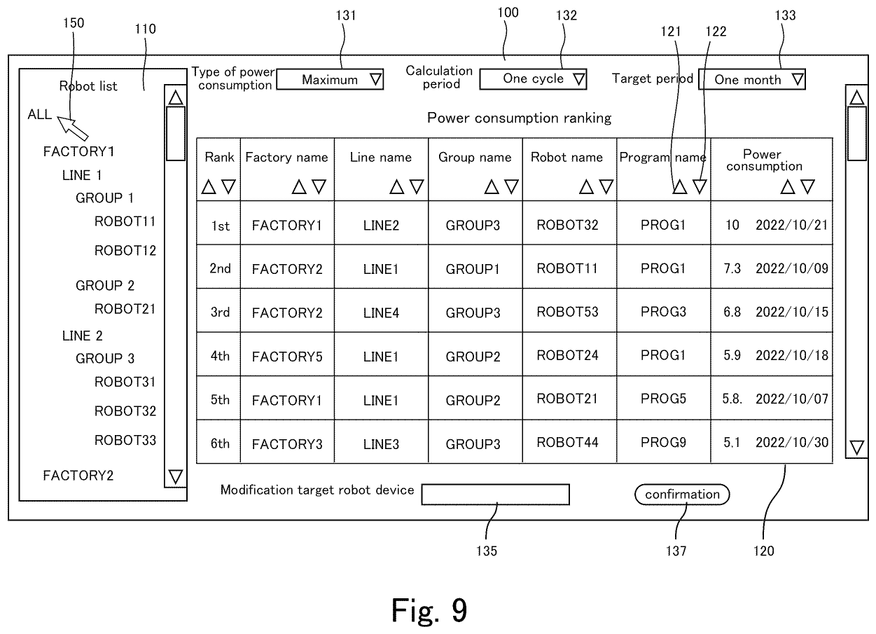

The power consumptions according to the display conditions set by the user are displayed in the table 120. The display conditions include the type of power consumption, the calculation period, and the target period. The first reception screen 100 is provided with a pull-down menu 131 for receiving the selection of a power consumption type from the user, a pull-down menu 132 for receiving the selection of a calculation period from the user, and a pull-down menu 133 for receiving the selection of a target period from the user. The list of the pull-down menu 131 includes power consumption types “maximum”, “minimum”, and “average”. The list of the pull-down menu 132 includes calculation periods “one cycle” and “one day”. The list of the pull-down menu 133 includes power consumption target periods “one week” and “one month”. For example, as shown in FIG. 6, when the power consumption type “maximum”, the calculation period “one cycle”, and the target period “one month” are set as the display conditions, the maximum value of the power consumption per cycle of the target robot device 3 in the most recent one month is displayed in the table 120. The power consumption may be displayed together with the date and time information of the execution of the cycle in which the power consumption was consumed (see FIG. 9).

The first reception screen 100 displays an input field 135 for inputting a robot device 3 whose operation program is to be modified and a confirmation button 137 for determining the robot device 3 whose operation program is to be modified. For example, the name of a robot device 3 is directly input to the input field 135. Based on the clicking of the confirmation button 137, the robot group including the robot device 3 input to the input field 135 is automatically set as a target for modification of the operation program, and the second reception screen is displayed on the display unit 22. Of course, the robot group including the robot device 3 whose operation program is to be modified may be input to the input field 135.

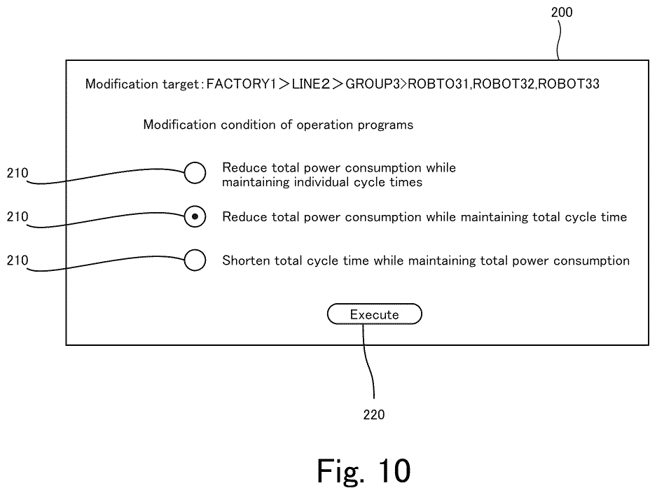

The second reception screen will be described below with reference to FIG. 10. FIG. 10 shows an example of the second reception screen created by the screen creation unit 25. The second reception screen has a function of receiving a modification condition of the operation programs. For example, as shown in FIG. 10, the second reception screen 200 displays a plurality of radio buttons 210 corresponding to a plurality of modification conditions and an execution button 220 that triggers the start of the processing for modifying the operation programs. The plurality of modification conditions include “reduce the total power consumption while maintaining the individual cycle times”, “reduce the total power consumption while maintaining the total cycle time”, and “shorten the total cycle time while maintaining the total power consumption”. Based on the clicking of the execution button 220, the modification condition corresponding to the radio button 210 selected by the user is set, and the third reception screen is displayed on the display unit 22.

Since it is possible to shorten the total cycle time while maintaining the total power consumption, it is possible to reduce the operation time while maintaining the power consumption. Therefore, the modification condition ‘shorten the total cycle time while maintaining the total power consumption’ is also a condition for substantially reducing the power consumption.

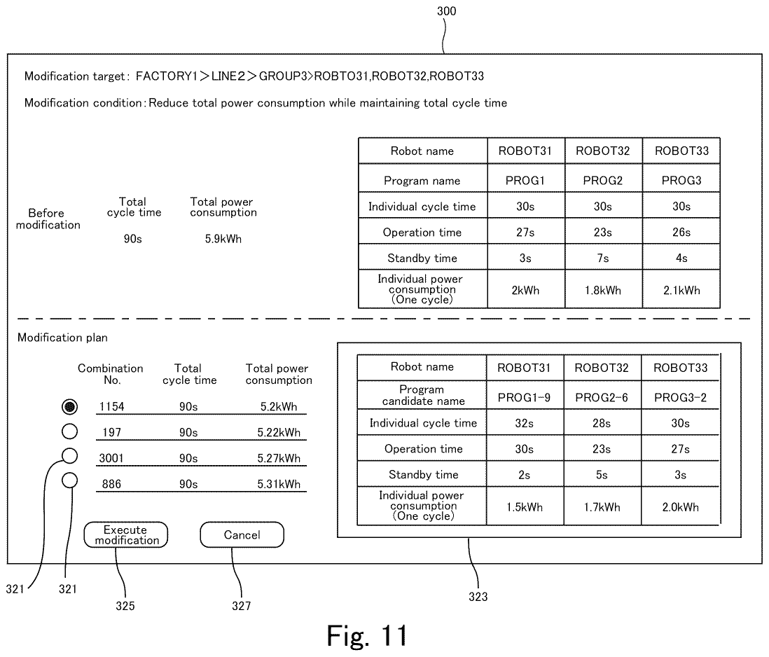

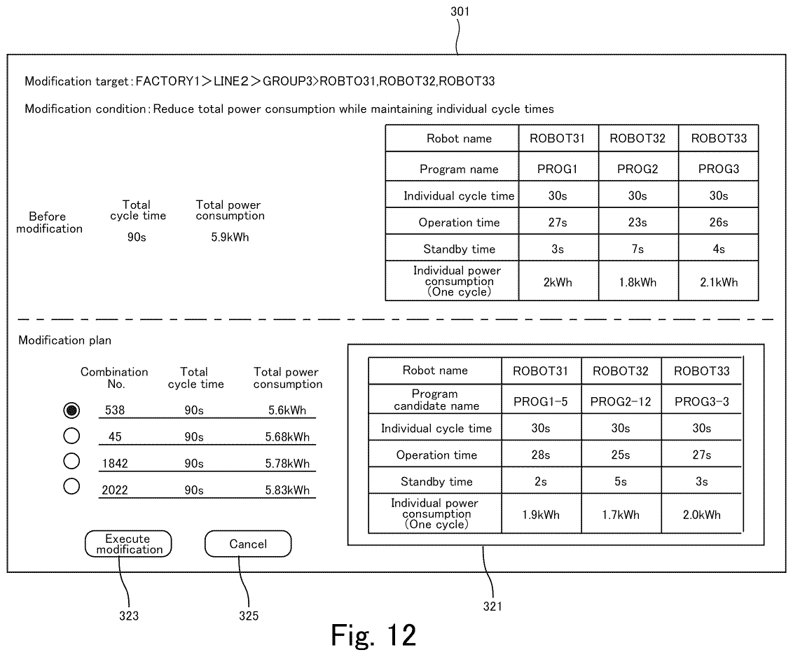

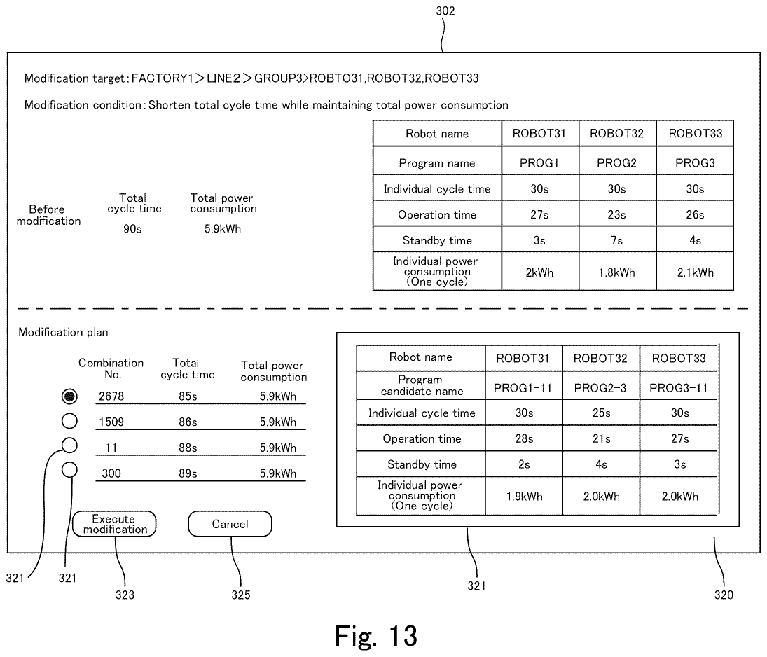

Hereinafter, the third reception screen will be described with reference to FIG. 11 to FIG. 13. FIG. 11, FIG. 12, and FIG. 13 each show an example of the third reception screen created by the screen creation unit 25. FIG. 11, FIG. 12, and FIG. 13 show the second reception screen when the modification conditions “reduce the total power consumption while maintaining the individual cycle times”, “reduce the total power consumption while maintaining the total cycle time”, and “shorten the total cycle time while maintaining the total power consumption” are selected, respectively.

The third reception screen has a function of presenting combinations of operation program candidates for the plurality of robot devices 3 to the user as operation program modification plans, a function of receiving a user selection of one combination from the plurality of presented combinations, and a function of receiving an operation program modification instruction. The third reception screens 300, 301, 302 shown in FIG. 11, FIG. 12, and FIG. 13 have the same screen configuration except for the combinations of operation program candidates presented as operation program modification plans. Therefore, here, the third reception screen will be described with reference to FIG. 11.

As shown in FIG. 11, the third reception screen 300 displays information related to the robot group (a plurality of robot devices 3) whose operation program is to be modified, information related to the modification condition, information related to the operation programs before modification of the respective robot devices 3 whose operation programs are to be modified, and outline information of a plurality of combinations of operation program candidates. A plurality of radio buttons 321 are associated with the plurality of combinations, respectively. In addition, the third reception screen 300 is provided with a detail display area 323 for displaying details of the combination selected by the user, a modification execution button 325 for receiving an operation program modification start instruction, and a stop button 327 for receiving a stop instruction of the operation program modification processing.

When one radio button 321 is selected from the plurality of radio buttons 321, detailed information of the combination of operation program candidates associated with the selected radio button 321 is displayed in the detail display area 323. The user confirms the details of the combination of operation program candidates displayed in the detail display area 322, and clicks the modification execution button 325, whereby the combination of operation program candidates corresponding to the selected radio button 321 can be selected as a modification plan to be used to modify the operation programs.

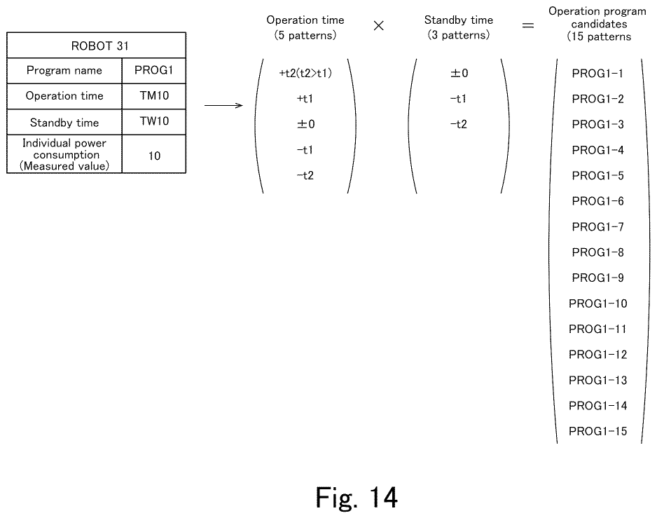

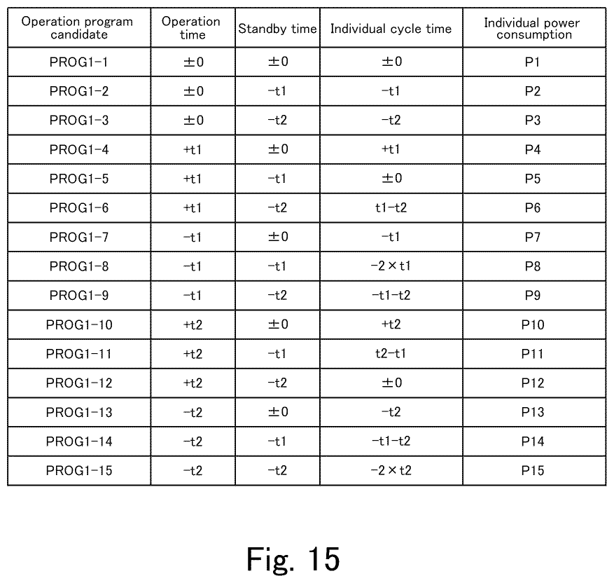

The processing for creating operation program candidates will be described below with reference to FIG. 14 and FIG. 15. FIG. 14 and FIG. 15 are supplementary diagrams for explaining the processing for creating operation program candidates.

Typically, the operation program candidate creation unit 27 creates a plurality of operation program candidates different in at least one of the operation time and the standby time based on the operation program being set. Here, an example of creating a plurality of program candidates from the operation program “PROG1” of the robot device 3 “ROBOT31” will be described. The operation time when the robot device 3 is operated in accordance with the operation program “PROG1” is denoted as “TM10”, and the standby time is denoted as “TW10”.

The operation program candidate creation unit 27 sets, as operation time patterns to be set in operation program candidates, a total of five patterns including the same operation time (±0) as the operation time TM10, two patterns (+t1, +t2 (t2>t1)) having an operation time longer than the operation time TM10, and two patterns (−t1, −t2) having a shorter operation time.

The operation program candidate creation unit 27 sets, as standby time patterns to be set in operation program candidates, a total of three patterns including the same standby time (±0) as the standby time TW10 and two patterns (−t1, −t2) having a standby time shorter than the standby time TW10.

The operation program candidate creation unit 27 creates a total of 15 operation program candidates (PROG1-1, PROG1-2, . . . , PROG1-15) by combining five patterns having different operation times and three patterns having different standby times in a round-robin manner.

Note that the operation program candidates created by the operation program candidate creation unit 27 may include an operation program candidate having the same operation time and standby time but a different operation parameter, such as an operation speed or an operation acceleration, with respect to the operation program being set.

As shown in FIG. 15, the individual cycle times corresponding to the operation program candidates created by the operation program candidate creation unit 27 are calculated by the cycle time calculation unit 28, and the individual power consumptions are calculated by the power consumption calculation unit 29.

As shown in FIG. 15, the speed and acceleration of the robot device 3 can be varied by varying the operation time, which in turn can vary the individual power consumption and individual cycle time. In addition, the individual cycle time of the robot device 3 can be varied by varying the standby time. As described above, the plurality of operation program candidates different in at least one of the operation time and the standby time include operation program candidates having different individual power consumptions and operation program candidates having different individual cycle times. Of course, the plurality of operation program candidates created by the operation program candidate creation unit 27 may include an operation program candidate having an operation time and standby time both matching those of the original operation program, and an operation program candidate different in at least one of the operation time and standby time from the original operation program.

The operation program candidate “PROG1-9” created based on the operation program “PROG1” is a program for making the operation time t1 longer and the standby time t2 shorter than when the robot device 3 is operated in accordance with the operation program “PROG1”. For example, in order to increase the operation time by t1, the operation speed of the robot device 3 is set to slow down uniformly in the operation program candidate “PROG1-9”. Of course, in the case where one cycle is constituted by a plurality of operations, the operation speed may be set to slow down only in a specific operation. Alternatively, the acceleration may be set to be gradual. For example, in order to decrease the standby time by t2, the standby time defined in the operation program candidate “PROG1-9” is decreased by t2. As described above, any method can be employed to vary the operation time or the standby time.

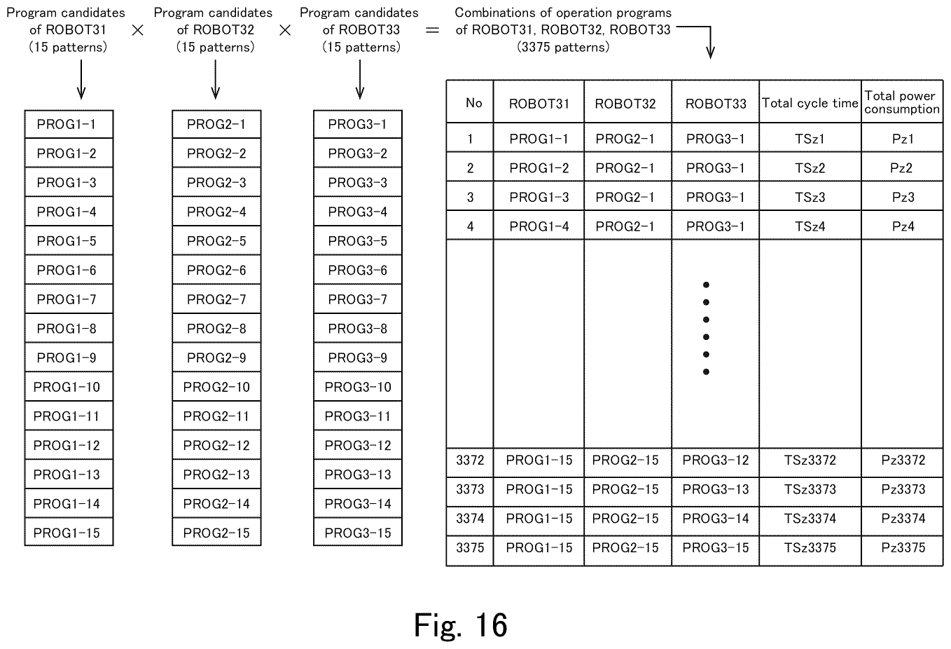

With reference to FIG. 11, FIG. 12, FIG. 13, and FIG. 16, processing for creating combinations of operation program candidates of the plurality of robot devices 3 by the combination creation unit 30 will be described. FIG. 16 is a supplementary diagram for explaining the processing for creating combinations of operation program candidates of the plurality of robot devices 3.

Here, as in FIG. 11, FIG. 12, and FIG. 13, a plurality of robot devices 3 whose operation programs are to be modified are referred to as “ROBOT31”, “ROBOT32”, and “ROBOT33”. The operation program candidate creation unit 27 creates 15 patterns of operation program candidates (PROG1-1, PROG1-2, . . . , PROG1-15) from the operation program “PROG1” of the robot device 3 “ROBOT31”, creates 15 patterns of operation program candidates (PROG2-1, PROG2-2, . . . , PROG2-15) from the operation program “PROG2” of the robot device 3 “ROBOT32”, and creates 15 patterns of operation program candidates (PROG3-1, PROG3-2, . . . , PROG3-15) from the operation program “PROG3” of the robot device 3 “ROBOT33”.

The combination creation unit 30 creates combinations of operation program candidates of the plurality of robot devices 3 so as to satisfy the modification condition. Specifically, the combination creation unit 30 creates a plurality of combinations of operation program candidates corresponding respectively to the plurality of robot devices 3 by combining a plurality of operation program candidates of the plurality of robot devices 3 in a round-robin manner. For example, as shown in FIG. 16, the combination creation unit 30 creates a total of 3375 patterns of combinations (No. 1 to No. 3375) of operation program candidates by combining 15 patterns of operation program candidates of the robot device 3 “ROBOT31”, 15 patterns of operation program candidates of the robot device 3 “ROBOT32”, and 15 patterns of operation program candidates of the robot device 3 “ROBOT33” in a round-robin manner.

The combination creation unit 30 calculates the total cycle time (TSz1 to TSz3375) and the total power consumption (Pz1 to Pz3375) for each of the plurality of combinations (No. 1 to No. 3375). The total cycle time can be calculated by adding the individual cycle times of the respective robot devices 3. Similarly, the total power consumption can be calculated by adding the individual power consumptions of the respective robot devices 3.

Then, the combination creation unit 30 extracts a combination that satisfies the modification condition from the plurality of combinations (No. 1 to No. 3375). The combination creation unit 30 can thereby create a combination of operation program candidates for the plurality of robot devices 3 so as to satisfy the modification condition.

For example, as shown in FIG. 11, FIG. 12, and FIG. 13, when the plurality of modification target robot devices 3 “ROBOT31”, “ROBOT32”, and “ROBOT33” operate in accordance with the operation programs “PROG1”, “PROG2”, and “PROG2”, respectively, the individual cycle time, the total cycle time, and the total power consumption are assumed to be “30 s”, “90 s” and “5.9 kwh”, respectively.

When the modification condition “reduce the total power consumption while maintaining the total cycle time” is set, as shown in FIG. 11, the combination creation unit 30 creates, from the plurality of combinations (No. 1 to No. 3375), a plurality of combinations (No. 194, No. 886, No. 1154, No. 3001) in which the total cycle time when the plurality of robot devices 3 operate in accordance with the operation program candidates matches 90 seconds and the total power consumption is less than 5.9 kwh. As shown in FIG. 11, the combinations (No. 194, No. 886, No. 1154, and No. 3001) created by the combination creation unit 30 that satisfy the modification condition are displayed from the top in order of lowest total power consumption.

When the modification condition “reduce the total power consumption while maintaining the individual cycle times” is set, as shown in FIG. 12, the combination creation unit 30 creates, from the plurality of combinations (No. 1 to No. 3375), a plurality of combinations (No. 45, No. 538, No. 1842, No. 2022) in which the individual cycle times when the plurality of robot devices 3 operates in accordance with the operation program candidates all match 30 seconds and the total power consumption is less than 5.9 kwh. As shown in FIG. 12, the combinations (No. 45, No. 538, No. 1842, and No. 2022) created by the combination creation unit 30 that satisfy the modification condition are displayed from the top in order of lowest total power consumption. Of course, if the total power consumption can be reduced, combinations in which the individual cycle times are shorter than 30 seconds may be created.

When the modification condition “shorten the total cycle time while maintaining the total power consumption” is set, as shown in FIG. 13, the combination creation unit 30 creates, from the plurality of combinations (No. 1 to No. 3375), a plurality of combinations (No. 11, No. 300, No. 1509, No. 2678) in which the total power consumption when the plurality of robot devices 3 operate in accordance with the operation program candidates match 5.9 kwh and the total cycle time is shorter than 90 seconds. As shown in FIG. 13, the combinations (No. 11, No. 300, No. 1509, and No. 2678) created by the combination creation unit 30 that satisfy the modification condition are displayed from the top in order of shortest total cycle time. Of course, if the total cycle time can be shortened, combinations in which the total cycle time is shorter than 90 seconds may be created.

The modification condition is not limited to the three conditions described above, and may include, for example, “reduce the total power consumption” and “shorten the total cycle time”. Therefore, the modification condition “reduce the total power consumption” is a condition that does not deny that the total cycle time becomes shorter or longer than 90 seconds if the total power consumption can be reduced. The modification condition “shorten the whole cycle time” is a condition that does not deny the increase or decrease of the total power consumption if the total cycle time can be shortened.

According to the information processing apparatus 2 of the present embodiment, the following effects are achieved.

The information processing apparatus 2 according to the present embodiment can display a list of power consumptions of a plurality of robot devices 3 to be managed in an arrangement according to the amount of power consumption (see FIG. 6 and FIG. 8) in order to assist the user in selecting a robot device 3 whose operation program is to be modified. As a result, the user can grasp the robot device 3 whose power consumption is high and select the robot device 3 whose power consumption is high as a target for modification of the operation program. In addition, the user can grasp a robot device 3 whose power consumption is abnormally low, and select the robot device 3 as a target for modification of the operation program.

The information processing apparatus 2 according to the present embodiment can display the power consumption together with information for identifying the factory where the robot device 3 is installed, information for identifying the line where the robot device 3 is arranged, information for identifying the group to which the robot device 3 belongs, and information for identifying the operation program. In addition, in accordance with these types of information, the power consumptions can be rearranged and displayed by line, group, or the like. The user can grasp the power consumptions of a plurality of robot devices 3 that operate in accordance with the same operation program by sorting by program name. For example, when the power consumptions of a plurality of robot devices 3 that operate in accordance with the same operation program are generally high, the plurality of robot devices 3 can be selected as the targets for modification of the operation program.

As described above, according to the information processing apparatus 2 of the present embodiment, a plurality of power consumptions can be rearranged and displayed by items such as the amount of the power consumption, the factory name, the line name, the group name, and the program name, so that the user can select the robot devices 3 whose operation program is to be modified from various viewpoints. This also contributes to assisting the user in modifying the operation program. Therefore, the information processing apparatus 2 according to the present embodiment may be configured as an assistance apparatus that assists the user in selecting a robot device 3 whose operation program is to be modified.

The information processing apparatus 2 according to the present embodiment can create a plurality of operation program candidates based on the operation programs of a plurality of robot devices 3 selected by the user, create combinations of operation program candidates for the plurality of robot devices 3 that satisfy the modification condition selected by the user, present the created combinations of operation program candidates to the user, and modify the operation programs of the plurality of robot devices 3 using the operation program candidates selected by the user, in order to assist the user in modifying the operation programs.

Any of the plurality of combinations of operation program candidates presented to the user can substantially reduce the power consumption. Therefore, the user can reduce the total power consumption of the plurality of robot devices 3 as compared with that before the modification by only selecting one combination from the plurality of presented combinations of operation program candidates.

The information processing apparatus 2 according to the present embodiment allows the user to finally determine a combination of operation program candidates to be used to modify the operation programs of the plurality of robot devices 3. Therefore, for example, the user can determine a combination to be used for modification from the presented combinations of operation program candidates after examining conditions such as the state of the workpiece, the surrounding environments of the robot devices 3, and the durabilities of the robot devices 3 that cannot be considered in the creation of the operation program candidates by the information processing apparatus 2. This suppresses the risk of occurrence of a failure that could damage the robot devices 3 or the workpiece due to the modification of the operation programs. This also contributes to assisting the user in modifying the operation programs. However, the information processing apparatus 2 according to the present embodiment may automatically select a combination of operation program candidates to be used to modify operation programs in accordance with a predetermined condition, and modify a plurality of operation programs corresponding to a plurality of robot devices 3.

The modification conditions presented to the user by the information processing apparatus 2 according to the present embodiment include “reduce the total power consumption while maintaining the total cycle time” and “shorten the total cycle time while maintaining the total power consumption”. These modification conditions are not conditions for focusing only on one robot device 3 to realize the reduction of the individual power consumption or the shortening of the individual cycle time of that one robot device 3, but are conditions for focusing on a plurality of robot devices 3 that execute one task in cooperation to realize the reduction of the power consumption or the shortening of the cycle time of the plurality of robot devices 3 as a whole.

For example, if one robot device 3 is focused on, the operation program can be modified only within the range of the individual cycle time of the robot device 3. Therefore, for the robot device 3 whose operation speed is set as slow as possible so as to fit within the individual cycle time in the existing operation program, no reduction in power consumption can be expected by modifying the operation program.

On the other hand, by focusing on a plurality of robot devices 3 that execute one task in cooperation, the individual cycle times set for the plurality of robot devices 3 can be allowed to be exceeded if the total cycle time of the plurality of robot devices 3 is not exceeded. Therefore, even when there is no factor for reducing the power consumption of a specific robot device 3, the operation program of the specific robot device 3 can be modified, for example, by shortening the individual cycle time of another robot device 3 cooperating with the specific robot device 3, and further reducing the operation speed within a range taking into account the shortened cycle time. As a result, although the power consumption of the other robot device 3 may increase, the power consumption of the specific robot device 3 can be reduced, and the total power consumption of the plurality of robot devices 3 can be reduced as compared with that before the modification. As described above, one feature of the information processing apparatus 2 according to the present embodiment is to be able to focus on a plurality of robot devices 3 that operate in cooperation so as to realize the reduction of the power consumption and the shortening of the cycle time of the plurality of robot devices 3 as a whole, instead of focusing only on one robot device 3 to realize the reduction of the individual power consumption and the shortening of the individual cycle time of the robot device 3.

The information processing apparatus 2 according to the present embodiment has a function of displaying data relating to the power consumption acquired from each of the robot devices 3. Typically, the plurality of power consumptions are listed in an arrangement according to the amount of the power consumption. For example, the user can select a robot device 3 whose power consumption is high as the robot device 3 to be modified by browsing a list of power consumptions arranged in order of highest power consumption. Assisting the user in selecting a modification target robot device 3 is a part of assisting the user in modifying the operation program. Therefore, the information processing apparatus according to the present embodiment may be configured to have only a function of displaying data relating to the power consumption acquired from each of the robot devices 3 in order to assist the user in modifying the operation program.

In the present embodiment, in order to assist the user in selecting a robot device 3 whose operation program is to be modified, the individual power consumptions of robot devices 3 can be displayed (see FIG. 6 etc.). However, the information processing apparatus 2 according to the present embodiment can collectively modify the operation programs of a plurality of robot devices 3 that operate in cooperation. Therefore, in order to assist the user in selecting a robot group whose operation programs are to be modified, the power consumption of each robot group may be displayed.

The various types of data stored in the storage device 9 may be distributed by being recorded on removable media, or may be distributed by being downloaded to the information processing apparatus 2 via the network 4.

The following appendixes are further disclosed with respect to the present embodiments and modifications.

### (Appendix 1)

An information processing apparatus 2 comprises a storage unit 24 to store a plurality of operation programs for individually controlling a plurality of robot devices 3 that execute a task in cooperation with each other, an operation program candidate creation unit 27 configured to create a plurality of operation program candidates with different individual power consumptions for each of the plurality of robot devices 3 based on the operation program of the robot device 3, and a combination creation unit 30 configured to create a combination of operation program candidates for the plurality of robot devices 3 so that a total value of individual power consumptions for the plurality of robot devices 3 is less than a total power consumption of the plurality of robot devices 3 when the robot devices 3 are operated in accordance with the operation programs.

### (Appendix 2)

In the information processing apparatus 2 described in Appendix 1, the combination creation unit 30 creates the combination of operation program candidates for the plurality of robot devices 3 so that a total value of individual cycle times for the plurality of robot devices 3 matches a total cycle time of the plurality of robot devices 3 when the robot devices 3 are operated in accordance with the operation programs and so that the total value of the individual power consumptions for the plurality of robot devices 3 is less than the total power consumption of the plurality of robot devices 3 when the robot devices 3 are operated in accordance with the operation programs.

### (Appendix 3)

In the information processing apparatus 2 described in Appendix 1, the combination creation unit 30 creates the combination of operation program candidates for the plurality of robot devices 3 so that individual cycle times of the plurality of robot devices 3 match individual cycle times when the robot devices 3 are operated in accordance with the operation programs and so that the total value of the individual power consumptions of the plurality of robot devices 3 is less than the total power consumption of the plurality of robot devices 3 when the robot devices 3 are operated in accordance with the operation programs.

### (Appendix 4)

An information processing apparatus 2 comprises a storage unit 24 to store a plurality of operation programs for individually controlling a plurality of robot devices 3 that execute a task in cooperation with each other, an operation program candidate creation unit 27 configured to create a plurality of operation program candidates with different individual cycle times for each of the plurality of robot devices 3 based on the operation program of the robot device 3, and a combination creation unit 30 configured to create a combination of operation program candidates for the plurality of robot devices 3 so that a total value of individual cycle times for the plurality of robot devices 3 is shorter than a total cycle time of the plurality of robot devices 3 when the robot devices 3 are operated in accordance with the operation programs.

### (Appendix 5)

In the information processing apparatus 2 described in Appendix 4, the combination creation unit creates the combination of operation program candidates for the plurality of robot devices 3 so that a total value of individual power consumptions for the plurality of robot devices 3 matches a total power consumption of the plurality of robot devices 3 when the robot devices 3 are operated in accordance with the operation programs and so that the total value of the individual cycle times for the plurality of robot devices 3 is shorter than the total cycle time of the plurality of robot devices 3 when the robot devices 3 are operated in accordance with the operation programs.

### (Appendix 6)

The information processing apparatus 2 described in any one of Appendixes 1 to 5 further comprises a display unit 22 to display a plurality of combinations of operation program candidates created by the combination creation unit 30, and a modification unit 31 configured to modify the operation programs of the plurality of robot devices 3 based on one combination selected by a user from the plurality of combinations.

### (Appendix 7)

An information processing apparatus 2 comprises an acquisition unit 23 configured to acquire data relating to a plurality of power consumptions respectively corresponding to a plurality of robots from a robot control device configured to control the plurality of robots, and a display unit 22 to display a list of the plurality of power consumptions in an arrangement according to amounts of the power consumptions.

### (Appendix 8)

In the information processing apparatus 2 described in Appendix 7, each of the power consumptions is displayed together with information for identifying a factory where the robot is installed, information for identifying a line where the robot is arranged, information for identifying a group to which the robot belongs, and information for identifying the operation program.

### (Appendix 9)

A program causes a computer configured to store a plurality of operation programs for individually controlling a plurality of robot devices 3 that execute a task in cooperation with each other to realize means for creating a plurality of operation program candidates with different individual power consumptions for the plurality of robot devices 3 based on the operation program of the robot device 3, and means for creating a combination of operation program candidates for the plurality of robot devices 3 so that a total value of individual power consumptions for the plurality of robot devices 3 is less than a total power consumption of the plurality of robot devices 3 when the robot devices 3 are operated in accordance with the operation programs.

While embodiments of the present disclosure have been described in detail, the present disclosure is not limited to the individual embodiments described above. These embodiments may be subjected to various additions, substitutions, modifications, partial deletions, etc., without departing from the gist of the invention or the idea and spirit of the present invention as derived from the contents described in the claims and their equivalents. For example, in the above-described embodiments, the order of the operations and the order of the processes are shown as examples, and the present invention is not limited thereto. The same applies to the case where numerical values or formulas are used in the description of the above-described embodiments.

1. An information processing apparatus comprising:
a storage unit to store a plurality of operation programs for individually controlling a plurality of industrial machines that execute a task in cooperation with each other;
an operation program candidate creation unit configured to create a plurality of operation program candidates with different individual power consumptions for each of the plurality of industrial machines based on the operation program of the industrial machine; and
a combination creation unit configured to create a combination of operation program candidates for the plurality of industrial machines so that a total value of individual power consumptions for the plurality of industrial machines is less than a total power consumption of the plurality of industrial machines when the industrial machines are operated in accordance with the operation programs.

2. The information processing apparatus according to claim 1, wherein the combination creation unit creates the combination of operation program candidates for the plurality of industrial machines so that a total value of individual cycle times for the plurality of industrial machines matches a total cycle time of the plurality of industrial machines when the industrial machines are operated in accordance with the operation programs and so that the total value of the individual power consumptions for the plurality of industrial machines is less than the total power consumption of the plurality of industrial machines when the industrial machines are operated in accordance with the operation programs.

3. The information processing apparatus according to claim 1, wherein the combination creation unit creates the combination of operation program candidates for the plurality of industrial machines so that individual cycle times of the plurality of industrial machines match individual cycle times when the industrial machines are operated in accordance with the operation programs and so that the total value of the individual power consumptions of the plurality of industrial machines is less than the total power consumption of the plurality of industrial machines when the industrial machines are operated in accordance with the operation programs.

4. An information processing apparatus comprising:
a storage unit to store a plurality of operation programs for individually controlling a plurality of industrial machines that execute a task in cooperation with each other;
an operation program candidate creation unit configured to create a plurality of operation program candidates with different individual cycle times for each of the plurality of industrial machines based on the operation program of the industrial machine; and
a combination creation unit configured to create a combination of operation program candidates for the plurality of industrial machines so that a total value of individual cycle times for the plurality of industrial machines is shorter than a total cycle time of the plurality of industrial machines when the industrial machines are operated in accordance with the operation programs.

5. The information processing apparatus according to claim 4, wherein the combination creation unit creates the combination of operation program candidates for the plurality of industrial machines so that a total value of individual power consumptions for the plurality of industrial machines matches a total power consumption of the plurality of industrial machines when the industrial machines are operated in accordance with the operation programs and so that the total value of the individual cycle times for the plurality of industrial machines is shorter than the total cycle time of the plurality of industrial machines when the industrial machines are operated in accordance with the operation programs.

6. The information processing apparatus according to claim 1, further comprising:
a display unit to display a plurality of combinations of operation program candidates created by the combination creation unit; and
a modification unit configured to modify the operation programs of the plurality of industrial machines based on one combination selected by a user from the plurality of combinations.

7. An information processing apparatus comprising:
an acquisition unit configured to acquire data relating to a plurality of power consumptions respectively corresponding to a plurality of robots from a robot control device configured to control the plurality of robots; and
a display unit to display a list of the plurality of power consumptions in an arrangement according to amounts of the power consumptions.

8. The information processing apparatus according to claim 7, wherein each of the power consumptions is displayed together with information for identifying a factory where the robot is installed, information for identifying a line where the robot is arranged, information for identifying a group to which the robot belongs, and information for identifying the operation program.

9. A non-transitory storage medium storing a program causing a computer which stores program for causing a computer configured to store a plurality of operation programs for individually controlling a plurality of industrial machines that execute a task in cooperation with each other to realize, to implement: the computer:
means for creating a plurality of operation program candidates with different individual power consumptions for each of the plurality of industrial machines based on the operation program of the industrial machine; and
means for creating a combination of operation program candidates for the plurality of industrial machines so that a total value of individual power consumptions for the plurality of industrial machines is less than a total power consumption of the plurality of industrial machines when the industrial machines are operated in accordance with the operation programs.
